(19) United States
(12) Patent Application Publication
(10) Pub. No.: US 2004/0087298 A1
(43) Pub. Date: May 6, 2004

(54) Local signal generation circuit

(75) Inventors: Taizo Yamawaki, Tokyo (JP); Satoshi Tanaka, Kokubunji (JP)

Correspondence Address: Stanley P. Fisher, Reed Smith LLP, 3110 Fairview Park Drive, Suite 1400, Falls Church, VA, 22042-4503, US

(73) Assignee: Renesas Technology Corp.

(21) Appl. No.: 10/682,928

(22) Filed: Oct. 14, 2003

(30) Foreign Application Priority Data
Nov. 6, 2002 (JP) 2002-322316

(51) Int. Cl. H04B 1/26; H04B 15/00

(52) U.S. Cl. 455/313

(57) ABSTRACT

The present invention relates to miniaturization of a local signal generation circuit to supply signals to a frequency converter in communication terminals such as a transmitter, a receiver, a transmitter-receiver, and the like that use one or more frequency bands. The local signal generation circuit comprises first and second oscillators capable of changing output frequencies and a multiplication means for multiplying input signals and generates local signals. The multiplication means selectively generates a signal of frequency corresponding to a sum or a difference between an output signal from the first oscillator and an output signal from the second oscillator.

### FIELD OF THE INVENTION

The present invention relates to miniaturization of a local signal generation circuit to supply signals to a frequency converter used for communication terminals such as a transmitter, a receiver, a transmitter-receiver, and the like that use one or more frequency bands.

### BACKGROUND OF THE INVENTION

In recent years, various communication systems coexist in the field of mobile communications. In accordance with this situation, mobile terminals need to comply with a plurality of frequency bands (multiband) or a plurality of communication systems (multimode). In Europe, for example, the mainstream is triple-band terminals compliant with communication systems such as the 900 MHz band GSM 900 (Global System for Mobile Communications 900 or hereafter referred to as GSM), the 1.8 GHz band DCS 1800 (Digital Cellular System 1800 or hereafter referred to as DCS), and the 1.9 GHz band PCS 1900 (Personal Communication System 1900 or hereafter referred to as PCS) In the future, it is expected to increasingly use dual mode terminals compliant with the 2 GHz band W-CDMA (Wide-band Code Division Multiple Access).

Such mobile terminal using a plurality of frequency bands needs to be able to obtain transmitter outputs in a plurality of frequency bands. For this purpose, there is provided a wide-band oscillator that covers a plurality of frequency bands as local signals for transmitter. Alternatively, there is provided a plurality of oscillators for respective frequency bands.

In the former case, however, it is difficult to manufacture an oscillator capable of generating wide-band outputs. In the latter case, the oscillator is normally manufactured as a module integrated into an IC chip. The oscillator increases its area and also increases mounting areas for the IC chip and the apparatus.

To solve the above-mentioned problems, for example JP-A No. 261103/1997 discloses the transmitter compliant with two frequency bands. FIG. 13 is a block diagram showing a representative configuration of the transmitter.

Input data 101 to be transmitted is supplied to a phase shifter 102. The phase shifter 102 is designed to be able to provide an appropriate phase shift amount so that transmitter output 111 becomes output data having a phase corresponding to the input data 101. An output from the phase shifter 102 is input to a baseband signal generator 103. A baseband signal 104 is output from the baseband signal generator 103 and is transmitted to a modulator 105. Supplied with the baseband signal 104, the modulator 105 outputs an intermediate frequency signal 106. The intermediate frequency signal 106 is input to a frequency converter 107. The frequency converter 107 is also supplied with a local signal for transmitter 108. The local signal for transmitter 108 is used to convert the frequency of the intermediate frequency signal 106 to generate an output signal 109. A filter 110 removes unneeded signal components from the output signal 109 to obtain a transmitter output 111 that selects the signal having a specified frequency band.

Operations of the transmitter will now be described. Let us consider obtaining frequency bands f1 an f2 for the transmitter output 111, where f1<f2. It is assumed that a frequency of the intermediate frequency signal 106 is fm and a frequency of the local signal for transmitter 108 is fL, where fL>fm. The following operations are needed to obtain frequency fL of the local signal for transmitter 108 and a frequency of the output signal 109. The frequency fL of the local signal for transmitter 108 is defined as f1+fm or f2−fm to stay in a range between f1 and f2. The frequency of the output signal 109 contains two frequency components fL+fm=f2 and fL−fm=f1. In order to obtain the f2 frequency band as the transmitter output 111, the filter 110 allows frequency components of f2 to pass through to remove frequency components of f1. In order to obtain the f2 frequency band, the filter 110 allows frequency components of f1 to pass through to remove frequency components of f2.

When the local signal for transmitter 108 causes frequency fL to be greater than f1, the phase shift of a signal obtained as the transmitter output 111 is reverse to the phase of the intermediate frequency signal 106. This reversal may be unfavorable for the phase of the transmitter output 111. In such case, the input signal phase is reversed by the phase shifter 102 that uses the input data 101 as input. The phase shifter 102 phase-shifts the input data 101 to produce an output and transmits this output to the baseband signal generator 103 so as to obtain the transmitter output 111 having a specified phase.

[Patent Document]

JP-A No. 261103/1997

### SUMMARY OF THE INVENTION

The conventional transmitter requires the filter 110 to remove a signal of unneeded frequency band, i.e., to remove f2 for obtaining the frequency band of f1 or to remove f1 for obtaining the frequency band of f2. However, mounting the filter increases areas for the circuit and the apparatus. Since the intermediate frequency signal 106 is used to generate signals of two frequency bands, the prior art cannot be applied to direct conversion receivers or direct up-conversion transmitters.

To solve the above-mentioned problems, the present invention uses a quadrature modulator for the local signal generation circuit that generates local signals. Further, the present invention enhances the degree of freedom for frequencies that can be generated by providing control so that an output frequency from the quadrature modulator becomes a sum or a difference between two input frequencies.

The present invention uses a quadrature modulator as a means for generating local signals. Further, the present invention enhances the degree of freedom for frequencies that can be generated by providing control so that an output frequency from the quadrature modulator becomes a sum or a difference between two input frequencies. The present invention decreases the number of necessary oscillators to a minimum (e.g., two). Accordingly, it is possible to miniaturize not only the RF-IC, but also the entire apparatus by miniaturizing the local signal generation circuit for supplying signals to a frequency converter.

### BRIEF DESCRIPTION OF THE DRAWINGS

FIG. 1 is a block diagram showing a configuration of a multimode terminal according to an embodiment of the present invention;

FIG. 2 is a table listing frequency band specifications for a wireless communication system;

FIG. 3 is a block diagram showing a detailed configuration of a local signal generation circuit according to a first embodiment;

FIG. 4 is a table showing correspondence between an oscillator and a switch in each communication system for the local signal generation circuit in FIG. 3;

FIG. 5 is a circuit diagram showing a detailed configuration of a 90° phase shifter;

FIG. 6 is a circuit diagram showing a detailed configuration of a quadrature modulator;

FIG. 7 is a block diagram showing a detailed configuration of a local signal generation circuit according to a second embodiment of the present invention;

FIG. 8 is a table showing correspondence between an oscillator and a switch in each communication system for the local signal generation circuit in FIG. 7;

FIG. 9 is a block diagram showing a detailed configuration of a local signal generation circuit according to a third embodiment of the present invention;

FIG. 10 is a table showing correspondence between an oscillator and a switch in each communication system for the local signal generation circuit in FIG. 9;

FIG. 11 is a block diagram showing a detailed configuration of a local signal generation circuit according to a fourth embodiment of the present invention;

FIG. 12 is a table showing correspondence between an oscillator and a switch in each communication system for the local signal generation circuit in FIG. 11; and

FIG. 13 is a block diagram showing a configuration of a conventional communication terminal.

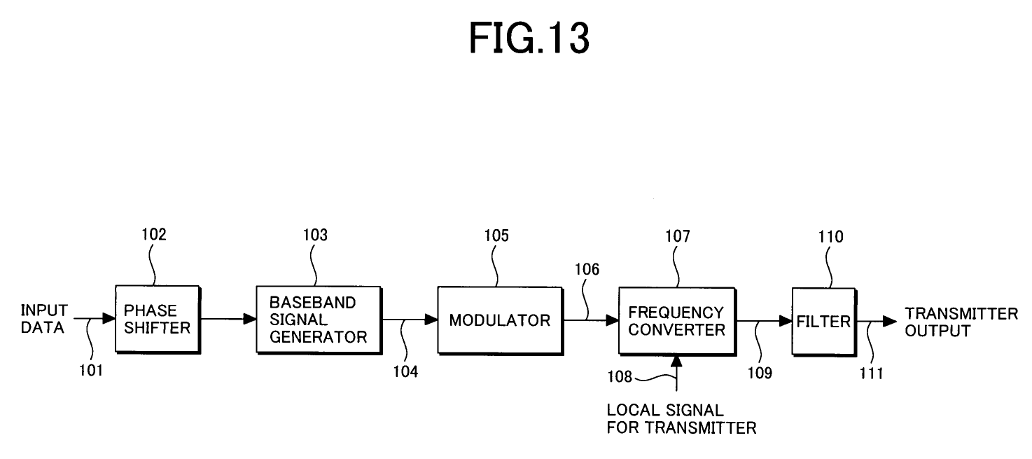

### DETAILED DESCRIPTION OF THE PREFERRED EMBODIMENTS

Embodiments of the present invention will be described in further detail with reference to the accompanying drawings.

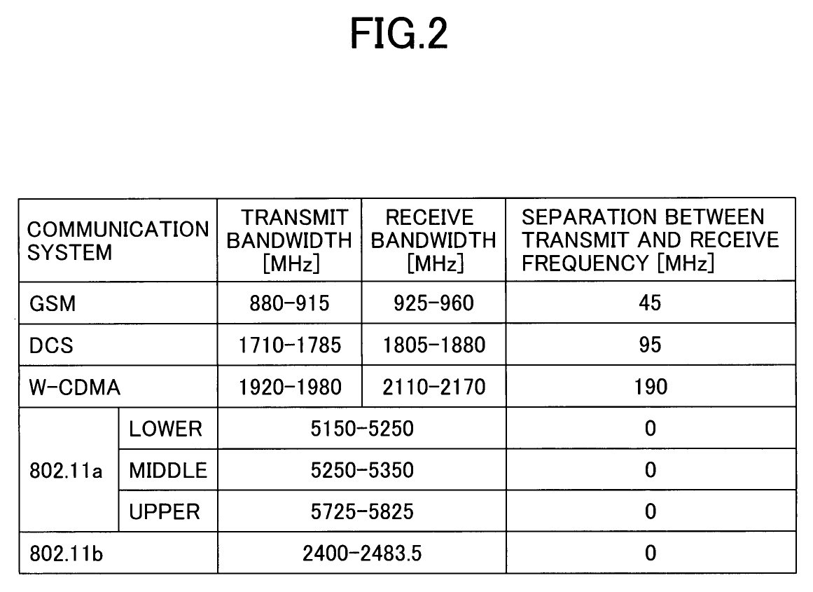

As already described in the background of the invention, various communication systems coexist in the mobile communication field. FIG. 2 shows frequency bands for typical communication systems. The 802.11a (hereafter referred to as 11a) and 802.11b (hereafter referred to as 11b) systems are IEEE 802.11 compliant wireless LAN specifications and are rapidly spreading in recent years. Applications of the multimode terminal include: GSM and DCS covering wide areas and providing voice services; wireless LAN compliant terminals, GSM, and DCS capable of fast data communication by covering narrow areas; and W-CDMA compliant terminals covering wide areas at a data rate lower than the wireless LAN.

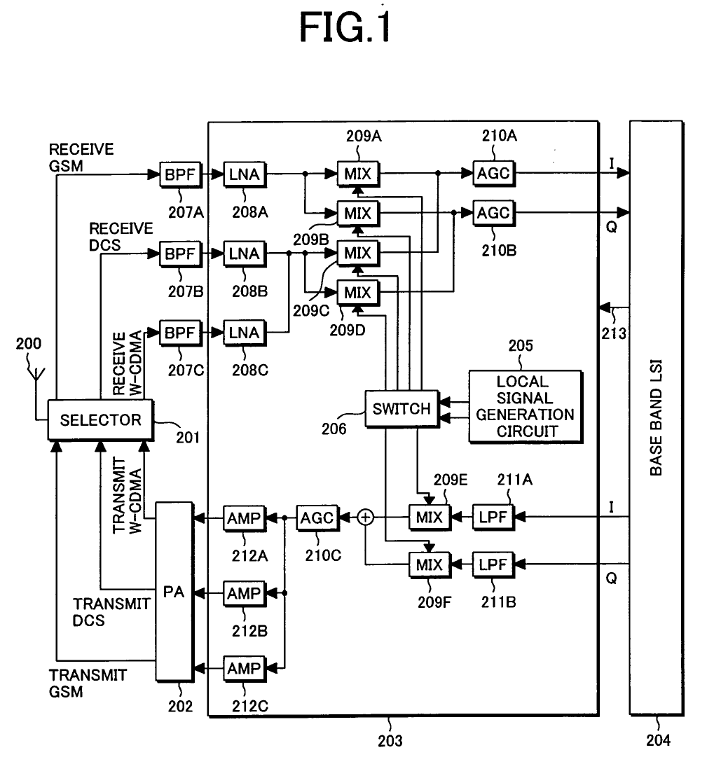

FIG. 1 is a block diagram showing a configuration of a multimode terminal according to the first embodiment of the present invention.

The multimode terminal according to the embodiment is compliant with three types of communication systems such as GSM, DCS, and W-CDMA. The multimode terminal comprises an antenna 200, a selector 201, bandpass filters (BPFs) 207A through 207C, a power amplifier (PA) 202, an RF-IC 203, and a baseband LSI 204.

The baseband LSI 204 processes voice or data signals to be transmitted to convert these signals into transmit baseband signals I and Q. The converted signals are transmitted to a low-pass filter (LPF) 211 in the RF-IC 203. When supplied with receive baseband signals I and Q from the RF-IC 203, the baseband LSI 204 applies a baseband signal to the receive baseband signals I and Q to decode them as voice or data signals.

When the baseband LSI 204 supplies a control signal 213 to the RF-IC 203, it is possible to control operations and characteristics of the RF-IC 203 based on the control signal. The RF-IC 203 is connected to the baseband LSI 204 through, e.g., a three-wire interface using an enable signal, a data signal, and a clock signal.

The RF-IC 203 comprises: low noise amplifiers (LNAs) 208A to 208C; frequency converters (MIXs) 209A to 209D; a direct conversion receiver comprising AGCs 210A to 210B; LPFs 211A and 211B; MIXs 209E and 209F; an AGC 210C; a direct up-conversion transmitter comprising buffer amplifiers (AMPs) 212A to 212C; a local signal generation circuit 205 to generate a local signal used in the MIXs 209A to 209F for frequency conversion; and an electronic switch 206 implemented by a semiconductor integrated circuit for selecting which of MIXs 209A to 209F should be supplied with a local signal generated in the local signal generation circuit 205.

A PA 202 is a power amplifier compliant with the GSM, DCS, and W-CDMA communication systems.

A selector 201 functions as follows. During a reception operation, the selector 201 selects any of the BPFs 207A to 207C corresponding to the communication systems as a transmission destination of a signal received by an antenna. During transmission, the selector 201 selects any of the communication systems corresponding to an output signal from the PA 202 to be transmitted to the antenna 200. In other words, the selector 201 comprises a so-called antenna switch, a duplexer, and a diplexer. The selector 201 may contain a filter for suppressing unneeded signals other than necessary signals.

To reduce an area, the RF-IC 203 allows one of some internal circuits to be shared by a plurality of communication systems. During operations as the receiver, however, sharing the MIXs 209A to 209D among all the communication systems may degrade reception characteristics due to an effect of parasitic elements between a group of the LNAs 208A to 208C and a group of MIXs 209A to 209D. Only the DCS and W-CDMA communication systems can share the MIXs 209C and 209D. The AGCs 210A and 210B are shared by all the communication systems. During operations as the transmitter, all the communication systems share the LPFs 211A and 211B, the MIXs 209E and 209F, and the AGC 210C.

The following describes in more detail operations of the multimode terminal according to the first embodiment.

When the GSM communication system is used, it complies with TDMA (Time Division Multiple Access), disabling transmission and reception from occurring simultaneously. During reception, the selector 201 supplies the BPF 207A with a signal received by the antenna 200 and suppresses unneeded signals. An output signal from the BPF 207A is input to the LNA 208A. The signal is given a specified gain and is input to the MIXs 209A and 209B. The MIXs 209A and 209B are supplied with local signals from the local signal generation circuit 205. Phases of these signals deviate from each other by 90°. Since the multimode terminal according to the embodiment uses the direct conversion system, frequencies of the local signals are the same as input signal frequencies for the MIXs 209A and 209B. That is to say, the local signals use the GSM receive bandwidth. The AGCs 210A and 210B convert frequencies of signals input from the LNA 208A by the local signals to output the baseband signals I and Q. The baseband signals are given specified gains by the AGCs 210A and 210B, are transmitted to the baseband LSI 204, and are decoded as voice or data signals. The AGCs 210A and 210B may contain LPFs to suppress unneeded signals. Gains for the AGCs 210A and 210B are determined based on information contained in the control signal 213.

During transmission, the baseband signals I and Q from the baseband LSI 204 are input to the LPFs 211A and 211B. After unneeded signals are suppressed, the baseband signals are input to the MIXs 209E and 209F. The MIXs 209E and 209F are supplied with local signals from the local signal generation circuit 205 via the switch 206. Phase of the local signals deviate from each other by 90°. Since the multimode terminal according to the embodiment uses the direct up-conversion system, frequencies of the local signals are the same as output signal frequencies for the MIXs 209E and 209F. That is to say, the local signals use the GSM transmit bandwidth. An addition is performed for output signals from the MIXs 209E and 209F. After an image signal is suppressed, the output signals are input to the AGC 210C and are given specified gains. Generally, a current addition is used for that addition. An output from the AGC 210C is transmitted to the AMP 212C. Gains for the AGC 210A are determined based on information contained in the control signal 213. An output signal from the AMP 212C is input to the PA 202, is given a gain, and then is transmitted from the antenna 200 via the selector 201.

Operations in the DCS communication system are similar to those in the GSM system. During reception, the selector 201 transmits a signal to a BPF 207B. The baseband signals I and Q are transmitted to the baseband LSI 204 via the MIXs 209C and 209D and the AGCs 210A and 210B and are decoded as voice or data signals. During transmission, a DCS transmit signal from the PA 202 is transmitted to the antenna 200 via the selector 201.

The W-CDMA communication system will be described below. The W-CDMA communication system is a non-TDMA system that allows transmission and reception to occur simultaneously. Accordingly, the selector 201 simultaneously transmits an output signal from the PA 202 to the antenna 200 and transmits a signal received by the antenna 200 to a BPF 207C. Further, the local signal generation circuit 205 simultaneously supplies local signals to the MIXs 209C, 209D, 209E, and 209F via the switch 206.

The above-mentioned multimode terminal may or may not use fixed characteristics for the LNA 208, the MIX 209, the LPF 211, and the AMP 212. It may be preferable to change the respective characteristics based on the information from the control signal 213 or in accordance with the communication systems, receive signal intensities, transmit signal intensities, and the like. In this manner, it is possible to improve the entire characteristics as the transmitter or the receiver.

The local signal generation circuit 205 will be described in detail.

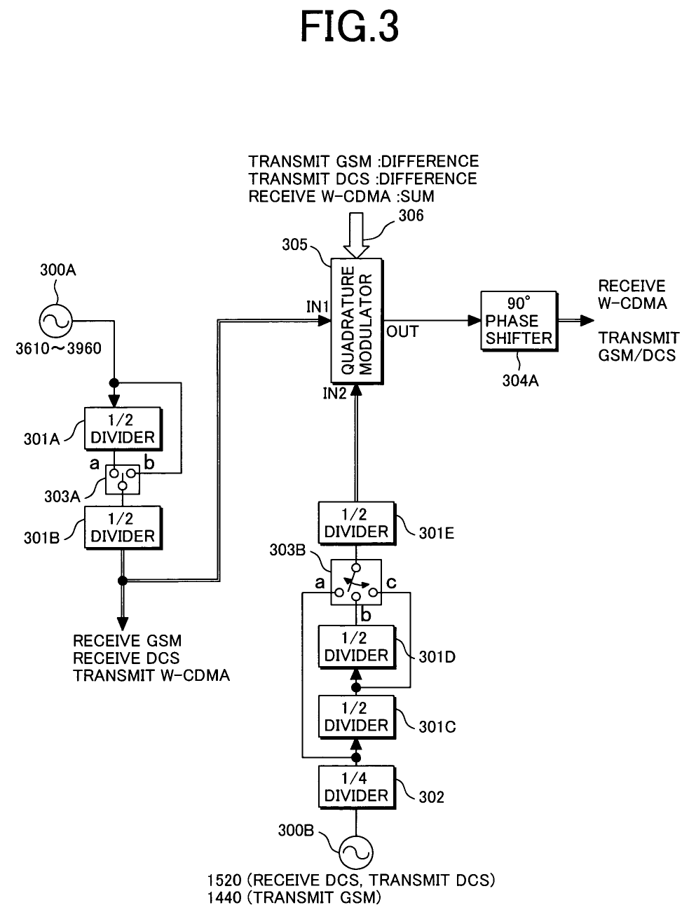

FIG. 3 is a block diagram showing a detailed configuration of the local signal generation circuit according to a first embodiment. Generally, when the RF-IC includes a transmitter-receiver and a local signal generation circuit and complies with GSM, DCS, PCS, and the like, the local signal generation circuit occupies a large part of the RF-IC area. The oscillator occupies approximately a half of the area of the local signal generation circuit. Accordingly, decreasing the number of oscillators is effective for decreasing the area of the local signal generation circuit. The embodiment employs the following configuration to decrease the number of oscillators.

The local signal generation circuit 205 according to the embodiment comprises two oscillators 300A and 300B, dividers 301 and 302, a switch 303, a quadrature modulator 305, and a 90° phase shifter 304.

The oscillator 300A generates frequency signals variably in the range between 3610 and 3960 MHz. The oscillator 300B generates frequency signals at 1520 MHz and 1440 MHz. Generally, a phase locked loop (PLL) is used to stabilize output signals from the oscillators 300A and 300B. Switches 303A and 303B are electronic switches implemented by semiconductor integrated circuits. The 90° phase shifter 304A inputs signals with the same frequency and generates two output signals having their phases deviated from each other by 90°. In FIG. 3, a signal path indicated by the double line signifies transmission of two signals having their phases deviated from each other by 90°. In addition, ½ dividers 301A to 301E also generate two signals having their phases deviated from each other by 90°. The quadrature modulator 305 has two input terminals IN1 and IN2 . The IN1 and IN2 are supplied with two signals having their phases deviated from each other by 90°.

Let us assume that input signal frequencies of the IN1 and IN2 correspond to f1 and f2, respectively, and that f1>f2. A control signal 306 can be used to control output signal frequencies of the quadrature modulator 305 based on either the sum of the input signal frequencies (f1+f2) or the difference between them (f1−f2). Operations of the quadrature modulator 305 will be described in detail later. The control signal 306 is generated based on information contained in the control signal 213 (FIG. 1).

The following describes operations of the local signal generation circuit configured as mentioned above with respect to the GSM, DCS, and W-CDMA communication systems.

When the GSM communication system is used, output frequencies of the oscillator 300A are set to a range between 3700 and 3840 MHz. At this time, the switch 303A is set to side a. An output signal from the oscillator 300A is divided by 4 after passing through the 1/2 dividers 301A and 301B to generate the GSM receive bandwidth of 925 to 960 MHz. At this time, the ½ divider 301B generates two signals having their phases deviated from each other by 90°. The two generated signals are transmitted to the switch 203 (FIG. 1) as local signals for GSM receiver.

During transmission like reception, the local signal generation circuit generates two signals 925 to 960 MHz having their phases deviated from each other by 90°. These signals are supplied as input signal 1 to the IN1 terminal of the quadrature modulator 305. On the other hand, an output frequency of the oscillator 300B is set to 1440 MHz. The switch 303B is set to side b. The 1440 MHz signal becomes a 45 MHz signal, i.e., a 1/32 signal, by passing through the ¼ divider 302, the ½ divider 301C, the ½ divider 301D, and the ½ divider 301E. At this time, the ½ divider 301E generates two signals having their phases deviated from each other by 90°. The two generated signals are supplied as input signal 2 to the IN2 terminal of the quadrature modulator 305.

The control signal 306 allows the output frequency from the quadrature modulator 305 to be a difference between input signal frequencies supplied to the IN1 and IN2. In this manner, the quadrature modulator 305 outputs the GSM transmit bandwidth of 880 to 915 MHz. The output signal from the quadrature modulator 305 is input to the 90° phase shifter 304A to generate two GSM transmit frequency band signals having their phases deviated from each other by 90°. The two generated signals are transmitted to the switch 203 as GSM local signals for transmitter.

When the DCS communication system is used, output frequencies of the oscillator 300A are set to a range between 3610 and 3760 MHz. At this time, the switch 303A is set to side b. An output signal from the oscillator 300A is divided by 2 after passing through the ½ divider 301B to generate the DCS receive bandwidth of 1805 to 1880 MHz. At this time, the ½ divider 301B generates two signals having their phases deviated from each other by 90°. The two generated signals are transmitted to the switch 203 (FIG. 1) as local signals for DCS receiver.

During transmission like reception, the local signal generation circuit generates two signals 1805 to 1880 MHz having their phases deviated from each other by 90°. These signals are supplied as input signal 1 to the IN1 terminal of the quadrature modulator 305. On the other hand, an output frequency of the oscillator 300B is set to 1520 MHz. The switch 303B is set to side c. An output signal from the oscillator 300B is divided by 16 after passing through the ¼ divider 302, the ½ divider 301C, and the ½ divider 301E to generate a 95 MHz signal. At this time, the ½ divider 301E generates two signals having their phases deviated from each other by 90°. The two generated signals are supplied as input signal 2 to the IN2 terminal of the quadrature modulator 305.

The control signal 306 allows the output frequency from the quadrature modulator 305 to be a difference between input signal frequencies supplied to the IN1 and IN2. In this manner, the quadrature modulator 305 outputs the DCS transmit bandwidth of 1710 to 1785 MHz. The output signal from the quadrature modulator 305 is input to the 90° phase shifter 304A to generate two DCS frequency band signals having their phases deviated from each other by 90°. The two generated signals are transmitted to the switch 203 as DCS local signals for transmitter.

When the W-CDMA communication system is used and a local signal for transmitter occurs, output frequencies of the oscillator 300A are set to a range between 3840 and 3960 MHz. At this time, the switch 301A is set to side b. An output signal from the oscillator 300A is divided by 2 after passing through the ½ divider 301A to generate the DCS receive bandwidth of 1920 to 1980 MHz. At this time, the ½ divider 301B generates two signals having their phases deviated from each other by 90°. The two generated signals are transmitted to the switch 203 (FIG. 1) as W-CDMA local signals for transmitter.

When a local signal for receiver occurs, signals of 1920 to 1980 MHz are generated in the same manner as occurrence of the local signal for transmitter. These signals are supplied as input signal 1 to the IN1 terminal of the quadrature modulator 305. On the other hand, an output frequency of the oscillator 300B is set to 1520 MHz. The switch 301B is set to side a. The 1520 MHz signal becomes a 190 MHz signal, i.e., a ⅛ signal, by passing through the ¼ divider 302 and the ½ divider 301E. At this time, the ½ divider 301E generates two signals having their phases deviated from each other by 90°. The two generated signals are supplied as input signal 2 to the IN2 terminal of the quadrature modulator 305.

The control signal 306 allows the output frequency from the quadrature modulator 305 to be a sum of input signal frequencies supplied to the IN1 and IN2. In this manner, an output frequency becomes the W-CDMA receive bandwidth of 2110 to 2170 MHz. The output signal from the quadrature modulator 305 is input to the 90° phase shifter 304A to generate two W-CDMA frequency band signals having their phases deviated from each other by 90°. The two generated signals are transmitted to the switch 203 as W-CDMA local signals for receiver.

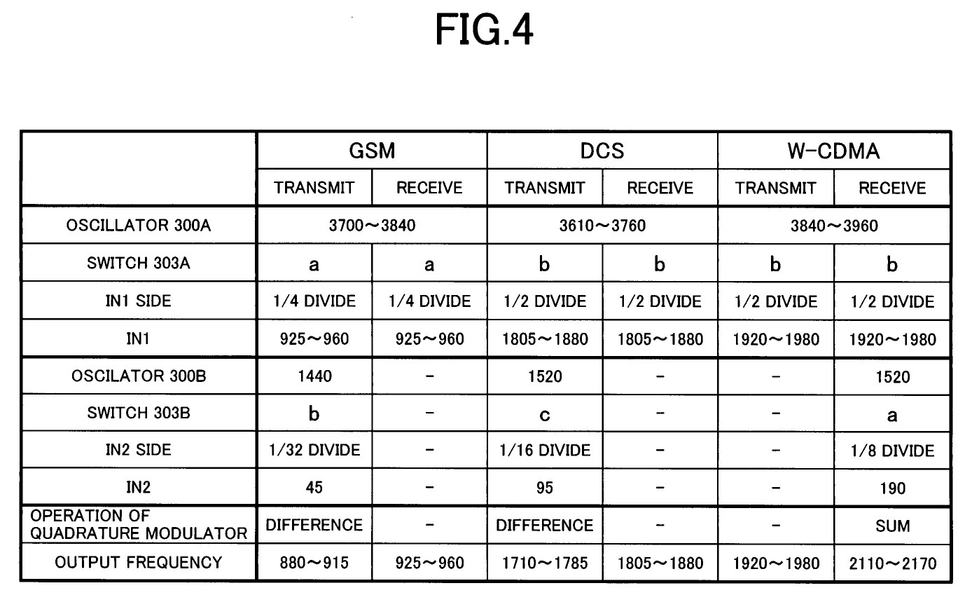

FIG. 4 is a table showing correspondence between a set of oscillators 300A and 300B and a set of switches 303A and 303B in each of the above-mentioned communication system.

The following describes in detail the above-mentioned 90° {phase shifter} 304A used for the local signal generation circuit.

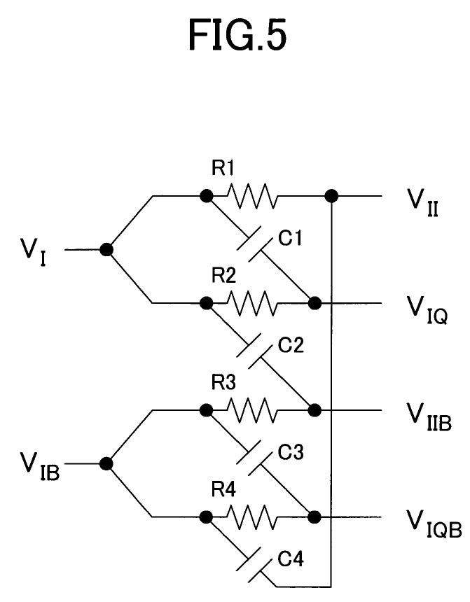

FIG. 5 is a circuit diagram showing a detailed configuration of the 90° phase shifter 304A.

The 90° phase shifter 304A uses a polyphase circuit. When an input differential signal V_{I}-V_{IB} is input to the polyphase circuit comprising resistor R and capacitor C, the circuit outputs two differential output signals having their phases deviated from each other by 90°, i.e., (V_{II}-V_{IIB}) and (V_{IQ}-V_{IQB}). The principle of polyphase circuit operations is described, e.g., in “CMOS Mixers and Polyphase Filters for Large Image Rejection” (Farbod Behbahani et al., IEEE Journal of Solid State Circuits, Vol. 36, No. 6, p. 873, June 2001).

The following describes in detail the {quadrature modulator} 305 used for the local signal generation circuit.

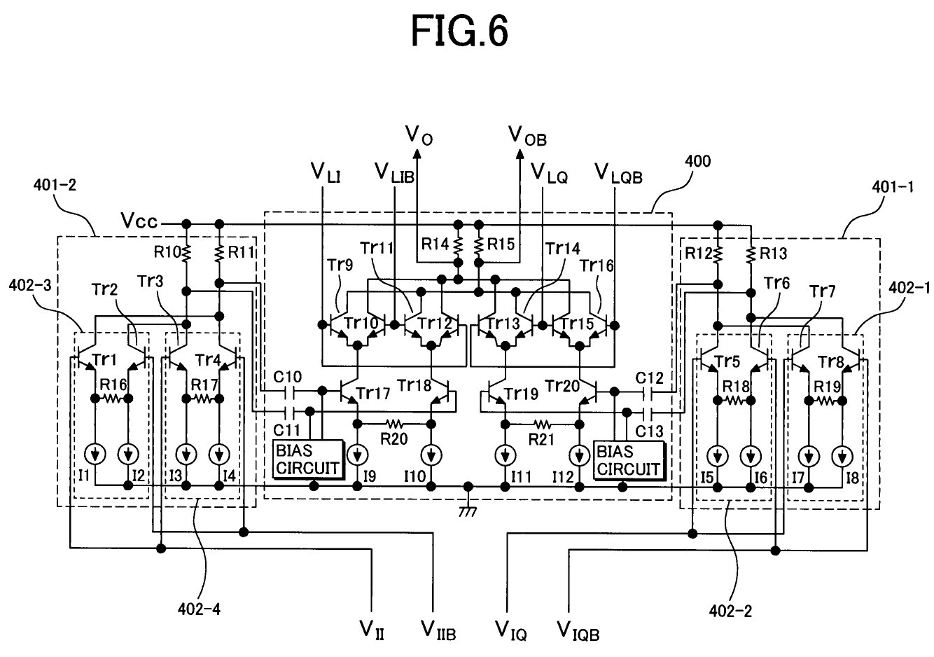

FIG. 6 is a circuit diagram showing a detailed configuration of the quadrature modulator 305.

The quadrature modulator 305 comprises a Gilbert multiplier 400 constituting a mixer circuit and a previous stage amplifier 401. The quadrature modulator 305 is supplied with the input signal 1 and the input signal 2. The input signal 1 comprises the differential signals (V_{II}-V_{IIB}) and (V_{IQ}-V_{IQB}). The input signal 2 comprises the differential signals (V_{LI}-V_{LIB}) and (V_{LQ}-V_{LQB}). The input signals 1 and 2 are two signals having their phases deviated from each other by 90°.

The current conversion circuits 402-1 through 402-4 convert first input signals into currents. The current conversion circuits 402A and 402B share loads R12 and R13. The current conversion circuits 402C and 402D share loads R10 and R11. Loads R10 through R13 are used to convert currents into voltages that are then input to the Gilbert multiplier 400. Of the current conversion circuit 402A through 402D, only two circuits operate simultaneously, i.e., either a combination of the current conversion circuits 402A and 402C or a combination of the current conversion circuits 402A and 402D. The current conversion circuit 402B works as a dummy circuit used to equalize an output impedance from the current conversion circuit 401A with the previous stage amplifier 401B. In the current conversion circuit 401, operating either set of circuits determines whether the output frequency of the quadrature modulator becomes a sum or a difference between two input signal frequencies. That is to say, operating a set of the current conversion circuits 401A and 401C outputs a sum of the input signals 1 and 2. Operating a set of the current conversion circuits 401A and 401D outputs a difference between the input signals 1 and 2. The control signal 306 (FIG. 3) turns on or off power supplies I1 through I8 to control operations of the current conversion circuits 402-1 through 402-4. The quadrature modulator 305 outputs a signal as a differential signal, i.e., (V_{O}-V_{OB}).

In the local signal generation circuit having the above-mentioned configuration, the oscillator 300A has an output frequency range between 3610 and 3960 MHz with reference to the entire frequency band. This signifies that a variable range is 9.2% with reference to the center frequency. It is possible to easily implement an oscillator providing frequency output having the variable range of 9.2% according to published documents such as “A1.8-GHz Low-Phase-Noise CMOS oscillator Using Optimized Hollow Spiral Inductors” (Jan Craninckx, et al., IEEE Journal of Solid-State Circuits, Vol. 32, No. 5, p. 736, May 1997) and the like.

As mentioned above, the multimode terminal according to the first embodiment complies with three communication systems GSM, DCS, and W-CDMA. Just two oscillators are used to configure the local signal generation circuit compliant with direct conversion receivers or direct up-conversion transmitters that are advantageous to miniaturization and low-price policy of mobile terminals. Miniaturizing the local signal generation circuit can miniaturize the RF-IC. As a result, the entire apparatus can be miniaturized.

The following describes the local signal generation circuit according to the second embodiment of the present invention.

The second embodiment uses the local signal generation circuit compliant with GSM, DCS, and 11b. The same parts or components as the first embodiment are depicted by the same reference numerals and a detailed description is omitted for simplicity.

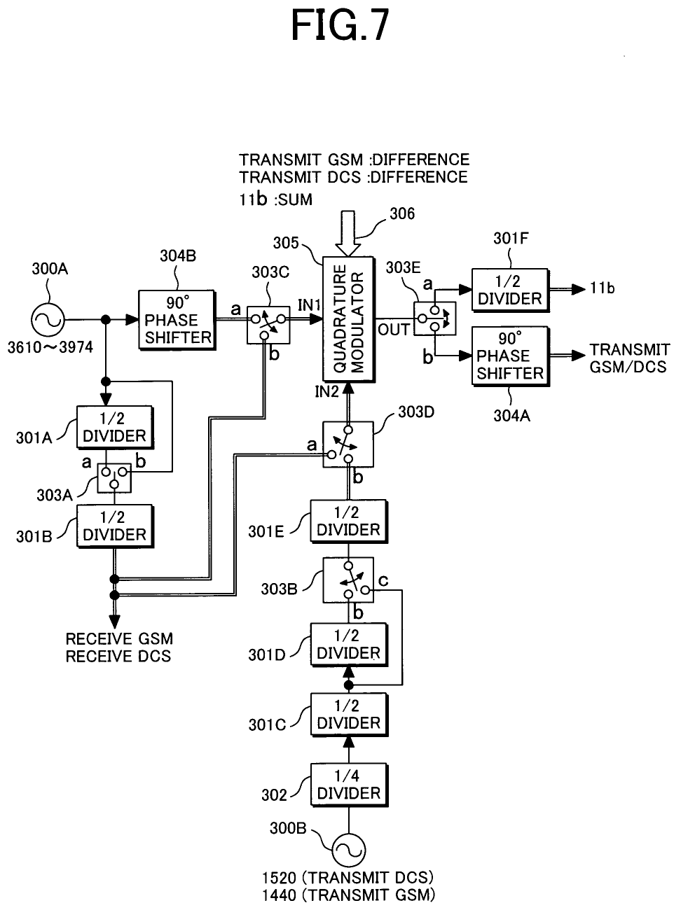

FIG. 7 is a block diagram showing a detailed configuration of the local signal generation circuit according to the second embodiment of the present invention.

The local signal generation circuit according to the second embodiment differs from the first embodiment in that there are added a 90° phase shifter 304B, switches 303C to 303E, and a ½ divider 301F.

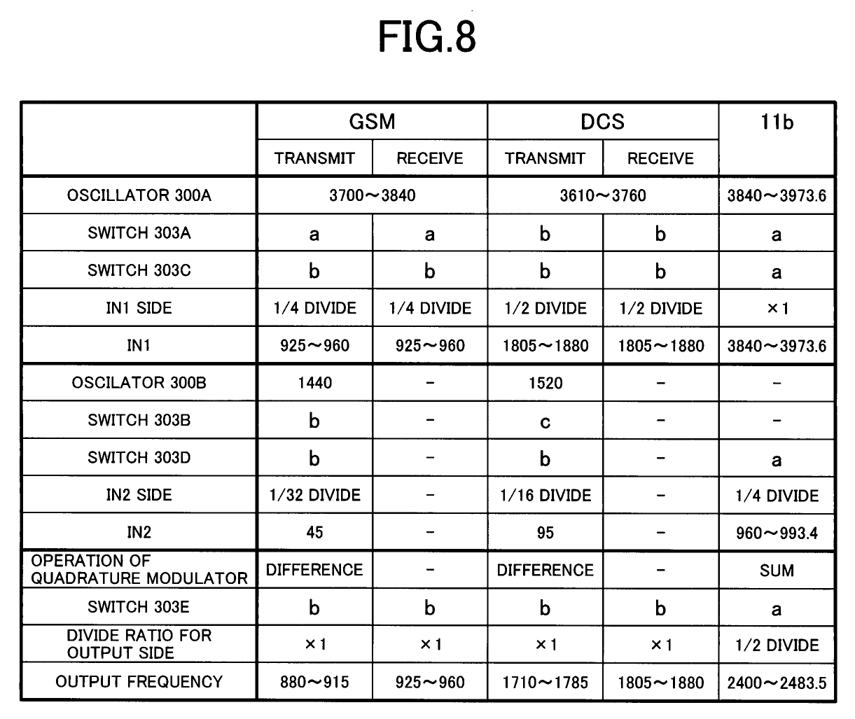

The second embodiment generates transmit and receive local signals for GSM and DCS in the same manner as the first embodiment. FIG. 8 lists correspondence between the oscillator 300 and the switch 303 for each communication system.

When the 11b communication system is used, output frequencies of the oscillator 300A are set to a range between 3840 and 3973.6 MHz. An output signal from the oscillator 300A is input to the 90° phase shifter 304B and is converted into two signals having their phases deviated from each other by 90°. These signals pass through the switch 303C set to side a and are supplied as an input signal 1 to the IN1 terminal of the quadrature modulator 305. At the same time, the switch 303A is set to side a. An output signal from the oscillator 300A is divided by 4 after passing through the ½ dividers 301A and 301B to generate frequencies of 960 to 993.4 MHz. At this time, the ½ divider 301B generates two signals having their phases deviated from each other by 90°. These signals pass through the switch 303D set to side a and are supplied as an input signal 2 to the IN2 terminal of the quadrature modulator 305.

The control signal 306 allows the output frequency from the quadrature modulator 305 to be a sum of input signal frequencies supplied to the IN1 and IN2. The output signal from the quadrature modulator 305 passes through the switch 303E set to side a and is divided by 2 after passing through the ½ divider 301F to generate the 11b bandwidth of 2400 to 2483.5 MHz. At this time, the ½ divider 301F generates two signals having their phases deviated from each other by 90°. The two generated signals are transmitted to the switch 203 as 11b local signals.

According to the above-mentioned configuration, the oscillator 300A has an output frequency range between 3610 and 3974 MHz with reference to the entire frequency band. This signifies that a variable range is 9.6% with reference to the center frequency. Like the first embodiment, it is possible to easily implement such oscillator.

As mentioned above, the local signal generation circuit for the multimode terminal according to the second embodiment complies with three communication systems GSM, DCS, and 11b. Like the first embodiment, just two oscillators are used to configure the local signal generation circuit. Miniaturizing the local signal generation circuit can miniaturize the RF-IC. As a result, the entire apparatus can be miniaturized.

The following describes the local signal generation circuit according to the third embodiment of the present invention.

The third embodiment uses the local signal generation circuit compliant with GSM, DCS, and 11a. The same parts or components as the first and second embodiments are depicted by the same reference numerals and a detailed description is omitted for simplicity.

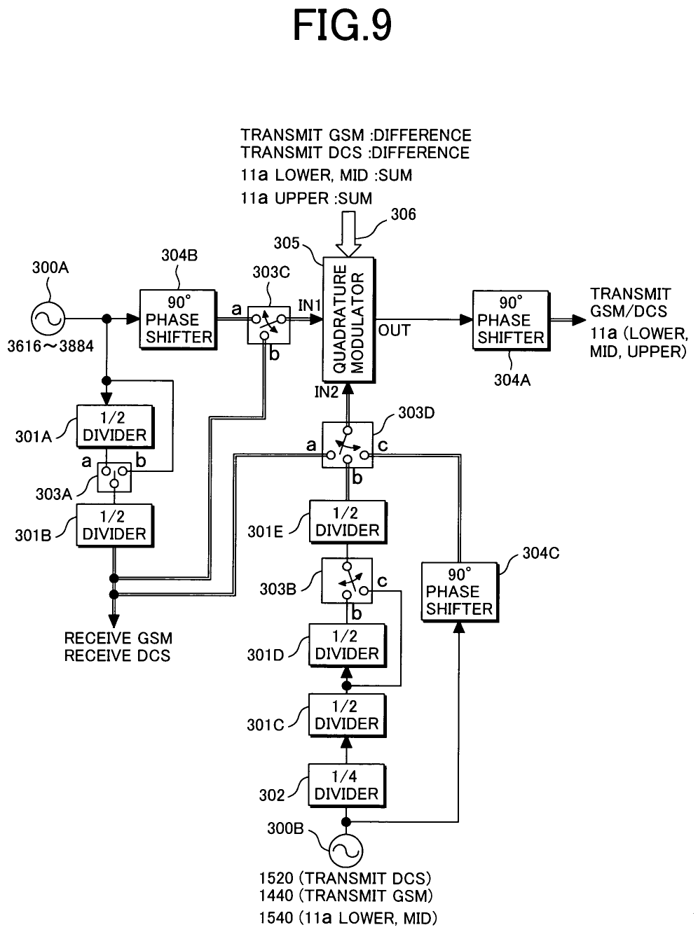

FIG. 9 is a block diagram showing a detailed configuration of the local signal generation circuit according to the third embodiment of the present invention.

The local signal generation circuit according to the third embodiment differs from the first embodiment in that there are added a 90° phase shifters 304B and 304C, and switches 303C and 303D.

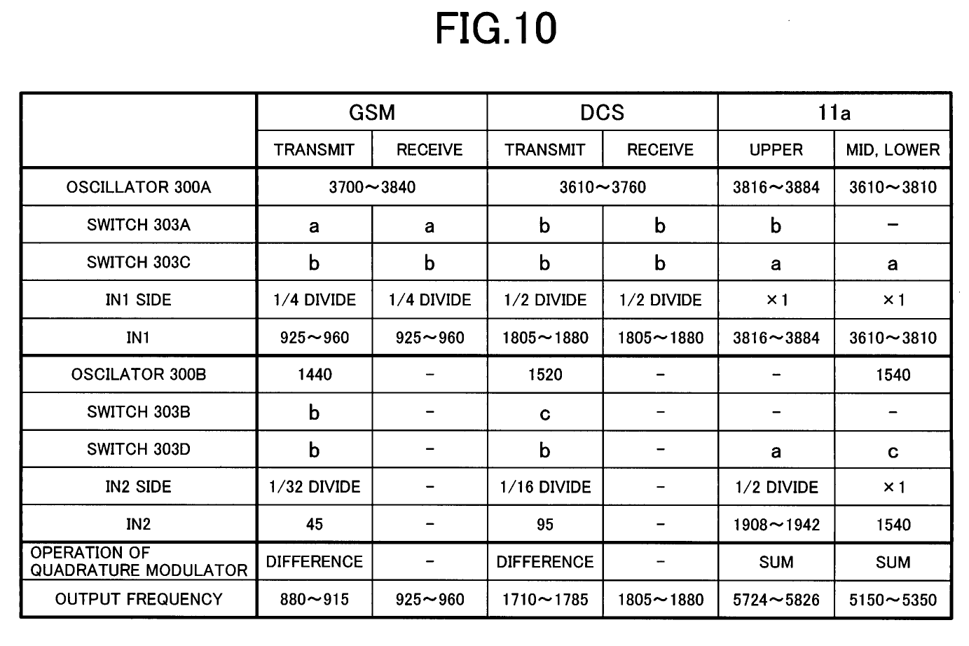

The third embodiment generates transmit and receive local signals for GSM and DCS in the same manner as the first embodiment and a detailed description is omitted for simplicity. FIG. 10 lists correspondence between the oscillator 300 and the switch 303 for each communication system.

When the 11a communication system is used, it is possible to use three types of frequency bands upper, mid, and lower.

When the upper frequency band is used, output frequencies of the oscillator 300A are set to a range between 3816 and 3884 MHz. An output signal from the oscillator 300A is input to the 90° phase shifter 304B and is converted into two signals having their phases deviated from each other by 90°. These signals pass through the switch 303C set to side a and are supplied as an input signal 1 to the IN1 terminal of the quadrature modulator 305. At the same time, the switch 303A is set to side b. An output signal from the oscillator 300A is divided by 2 after passing through the ½ divider 301B to generate frequencies of 1908 to 1942 MHz. At this time, the ½ divider 301B generates two signals having their phases deviated from each other by 90°. These signals pass through the switch 303D set to side a and are supplied as an input signal 2 to the IN2 terminal of the quadrature modulator 305.

The control signal 306 allows the output frequency from the quadrature modulator 305 to be a sum of input signal frequencies supplied to the IN1 and IN2. It is possible to generate frequencies of 5724 to 5826 MHz containing the upper 11a bandwidth of 5725 to 5825 MHz. Using an output from the quadrature modulator, the 90° phase shifter 304A generates two signals having their phases deviated from each other by 90°. The two generated signals are transmitted to the switch 203 as upper 11a local signals.

When the lower or mid frequency band is used, output frequencies of the oscillator 300A are set to a range between 3610 and 3810 MHz. An output signal from the oscillator 300A is input to the 90° phase shifter 304B and is converted into two signals having their phases deviated from each other by 90°. These signals pass through the switch 303B set to side a and are supplied as an input signal 1 to the IN1 terminal of the quadrature modulator 306. On the other hand, output frequencies of the oscillator 300B are set to 1540 MHz. An output signal from the oscillator 300B is input to the 90° phase shifter 304C and is converted into two signals having their phases deviated from each other by 90°. These signals pass through the switch 303F set to side c and are supplied as an input signal 2 to the IN2 terminal of the quadrature modulator 305.

The control signal 306 allows the output frequency from the quadrature modulator 305 to be a sum of input signal frequencies supplied to the IN1 and IN2. It is possible to generate the lower and mid 11a bandwidths of 5150 to 5350 MHz. Using an output from the quadrature modulator, the 90° phase shifter 304A generates two signals having their phases deviated from each other by 90°. The two generated signals are transmitted to the switch 203 as upper 11a local signals.

When the above-mentioned configuration is used, the oscillator 300A has an output frequency range between 3610 and 3884 MHz with reference to the entire frequency band. This signifies that a variable range is 7.1% with reference to the center frequency. Like the first embodiment, it is possible to easily implement such oscillator.

As mentioned above, the local signal generation circuit for the multimode terminal according to the third embodiment complies with three communication systems GSM, DCS, and 11a. Like the first embodiment, just two oscillators are used to configure the local signal generation circuit. Miniaturizing the local signal generation circuit can miniaturize the RF-IC. As a result, the entire apparatus can be miniaturized.

The following describes the multimode terminal according to the fourth embodiment of the present invention.

The fourth embodiment uses the local signal generation circuit compliant with GSM, DCS, W-CDMA, 11a, and 11b. The same parts or components as the first, second, and third embodiments are depicted by the same reference numerals and a detailed description is omitted for simplicity.

The local signal generation circuit according to the third embodiment differs from the first embodiment in that there are added a 90° phase shifters 304B and 304C, and switches 303C and 303D.

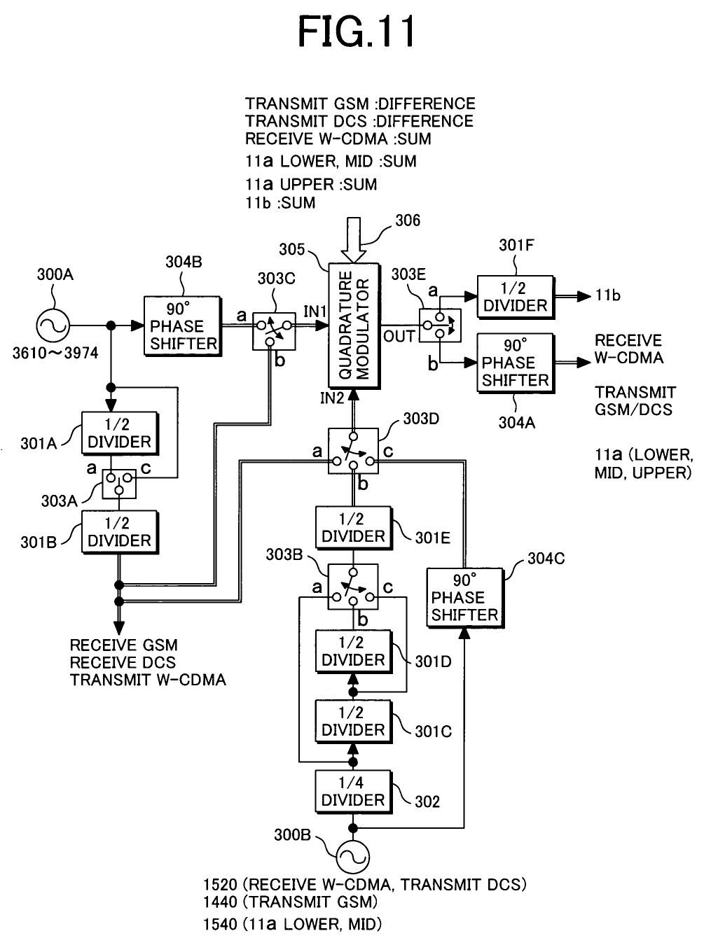

FIG. 11 is a block diagram showing a detailed configuration of the local signal generation circuit according to the fourth embodiment of the present invention.

The local signal generation circuit according to the fourth embodiment differs from the third embodiment in that there are added a 90° phase shifters 304B and 304C, and switches 303C through 303E, and the ½ divider 301F.

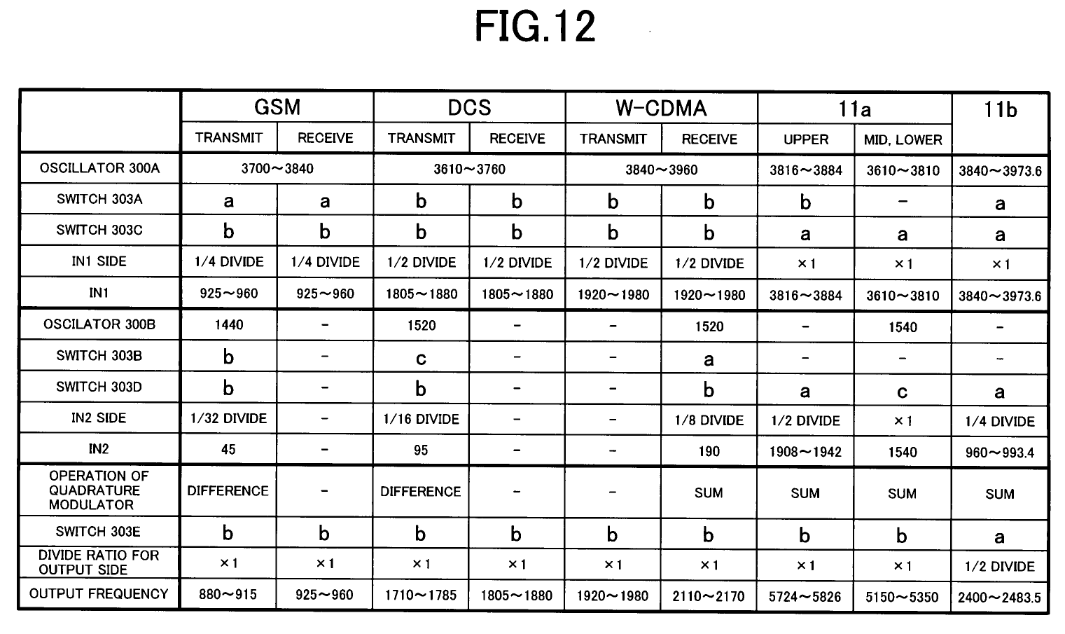

Operations of the GSM, DCS, W-CDMA, 11a, and 11b communication systems are the same as those described for the first, second, and third embodiments and a detailed description is omitted for simplicity. FIG. 12 lists correspondence between the oscillator 300 and the switch 303 for each communication system.

When the above-mentioned configuration is used, the oscillator 300A has an output frequency range between 3610 and 3974 MHz in total. This signifies that a variable range is 9.6% with reference to the center frequency. It is possible to easily implement such oscillator.

As mentioned above, the local signal generation circuit for the multimode terminal according to the fourth embodiment complies with five communication systems GSM, DCS, W-CDMA, 11a, and 11b. Like the first embodiment, just two oscillators are used to configure the local signal generation circuit. Miniaturizing the local signal generation circuit can miniaturize the RF-IC. As a result, the entire apparatus can be miniaturized.

While the present invention has been described mainly with respect to the communication systems such as the GSM, DCS, W-CDMA, and wireless LANs (11a and 11b), the present invention can be also applied to the other combinations. Further, the present invention can be applied to the multimode terminal in combination with the other communication systems.

What is claimed is:

1. A local signal generation circuit to generate local signals, comprising:
first and second oscillators capable of changing output frequencies; and
a multiplication means for multiplying input signals,
wherein the multiplication means selectively generates a signal of frequency corresponding to a sum or a difference between an output signal from the first oscillator and an output signal from the second oscillator.

2. The local signal generation circuit according to claim 1,
wherein the multiplication means comprises a quadrature modulator.

3. The local signal generation circuit according to claim 2,
wherein the quadrature modulator comprises a mixer circuit.

4. The local signal generation circuit according to claim 1,
wherein the local signal generation circuit comprises one or more dividers to divide at least one of signals output from the first and second oscillators to input the signal to the multiplication means and selectively uses the dividers to change the mixer frequency.

5. The local signal generation circuit according to claim 2,
wherein the local signal generation circuit comprises one or more dividers to divide at least one of signals output from the first and second oscillators to input the signal to the multiplication means and selectively uses the dividers to change the mixer frequency.

6. The local signal generation circuit according to claim 1, further comprising:
a first phase shift means for converting signals output from the first oscillator into two signals having their phases deviated from each other by 90 degrees; and
a second phase shift means for converting signals output from the second oscillator into two signals having their phases deviated from each other by 90 degrees,
wherein an output signal from the first phase shift means and an output signal from the second phase shift means are input to the multiplication means.

7. The local signal generation circuit according to claim 2, further comprising:
a first phase shift means for converting signals output from the first oscillator into two signals having their phases deviated from each other by 90 degrees; and
a second phase shift means for converting signals output from the second oscillator into two signals having their phases deviated from each other by 90 degrees,
wherein an output signal from the first phase shift means and an output signal from the second phase shift means are input to the multiplication means.

8. The local signal generation circuit according to claim 2, further comprising:
a first phase shift means for converting signals output from the first oscillator into two signals having their phases deviated from each other by 90 degrees; and
a second phase shift means for converting signals output from the second oscillator into two signals having their phases deviated from each other by 90 degrees,
wherein an output signal from the first phase shift means and an output signal from the second phase shift means are input to the multiplication means.

9. The local signal generation circuit according to claim 2,
wherein the phase shift means includes a polyphase circuit.

10. A high-frequency module comprising:
first and second oscillators capable of changing output frequencies; and
a multiplication means for multiplying input signals,
wherein the multiplication means has a local signal generation circuit to selectively generate a signal of frequency corresponding to a sum or a difference between an output signal from the first oscillator and an output signal from the second oscillator.

11. The high-frequency module according to claim 10,
wherein the multiplication means comprises a quadrature modulator.

12. The high-frequency module according to claim 10, further comprising:
a filter to suppress unnecessary frequency components in a receive signal;
an amplifier to amplify a signal passing through the filter; and
a mixer to convert frequencies by mixing a signal amplified by the amplifier and a local signal generated by the local signal generation circuit.

13. The high-frequency module according to claim 11, further comprising:
a filter to suppress unnecessary frequency components in a receive signal;
an amplifier to amplify a signal passing through the filter; and
a mixer to convert frequencies by mixing a signal amplified by the amplifier and a local signal generated by the local signal generation circuit.

14. The high-frequency module according to claim 10, further comprising:
a baseband signal processing means for generating a baseband signal;
a mixer to convert frequencies by mixing a signal generated by the baseband signal processing means and the local signal generated by the local signal generation circuit; and
an amplifier to amplify a signal mixed by the mixer.

15. The high-frequency module according to claim 11, further comprising:
a baseband signal processing means for generating a baseband signal;
a mixer to convert frequencies by mixing a signal generated by the baseband signal processing means and the local signal generated by the local signal generation circuit; and
an amplifier to amplify a signal mixed by the mixer.

16. The high-frequency module according to claim 12, further comprising:
a baseband signal processing means for generating a baseband signal;
a mixer to convert frequencies by mixing a signal generated by the baseband signal processing means and the local signal generated by the local signal generation circuit; and
an amplifier to amplify a signal mixed by the mixer.

17. A communication terminal comprising:
a local signal generation circuit;
a receiver means for processing a signal received by an antenna;
a transmit means for processing a signal to be transmitted from the antenna,
wherein the local signal generation circuit comprises:
first and second oscillators capable of changing output frequencies; and
a multiplication means for multiplying input signals,
wherein the multiplication means generates a local signal by selectively generating a local signal of frequency corresponding to a sum or a difference between an output signal from the first oscillator and an output signal from the second oscillator.
wherein the receive means comprises:
a filter to suppress unnecessary frequency components in a receive signal;
an amplifier to amplify a signal passing through the filter; and
a mixer to convert frequencies by mixing a signal amplified by the amplifier and a local signal generated by the local signal generation circuit.

18. The communication terminal according to claim 17,
wherein the transmit means comprises:
a baseband signal processing means for generating a baseband signal;
a mixer to convert frequencies by mixing a signal generated by the baseband signal processing means and the local signal; and
an amplifier to amplify a signal mixed by the mixer.

19. The communication terminal according to claim 17,
wherein the multiplication means comprises a quadrature modulator.

20. The communication terminal according to claim 18,
wherein the multiplication means comprises a quadrature modulator.
